(19) United States
(12) Patent Application Publication
(10) Pub. No.: US 2026/0162336 A1
(43) Pub. Date: Jun. 11, 2026

(54) MEDIA PROCESSING METHOD, APPARATUS, DEVICE AND MEDIUM

(71) Applicant: Beijing Zitiao Network Technology Co., Ltd., Beijing (CN)

(72) Inventors: Weilun WANG, Beijing (CN); Hao XUE, Beijing (CN); Xiwei HU, Beijing (CN); Haokun CHEN, Beijing (CN)

(21) Appl. No.: 19/407,983

(22) Filed: Dec. 3, 2025

(30) Foreign Application Priority Data
Dec. 6, 2024 (CN) 202411795318.3

(51) Int. Cl. G06T 11/60; G06V 10/77; G06V 10/80

(52) U.S. Cl. CPC G06T 11/60; G06V 10/7715; G06V 10/80

(57) ABSTRACT

The present disclosure provides a media processing method, an apparatus, a device, and a medium. A specific implementation of the method includes: acquiring an original media to be modified and guidance information, where the guidance information includes text information for performing modification on the original media; determining a first area to be modified in the original media; acquiring a reference feature for modifying the original media based on the guidance information; and performing modification on the first area in the original media based on the reference feature to obtain a target media.

### CROSS REFERENCE TO RELATED APPLICATIONS

The present application is based on and claims priority to Chinese Patent Application No. 202411795318.3 filed on Dec. 6, 2024, the disclosure of which is incorporated by reference herein in its entirety.

### TECHNICAL FIELD

Embodiments of the present disclosure relate to the technical field of image processing and, in particular, to a media processing method, an apparatus, a device, and a medium.

### BACKGROUND

With the continuous development of artificial intelligence technology, artificial intelligence technology is increasingly applied to the field of media processing. At present, it has been possible to generate a media (such as an image or a video, etc.) as desired by a user by an artificial intelligence model. However, in some cases, the media needs to be modified. For example, errors exist in the generated media, or the user wants to adjust contents in some areas of the media, etc. In related technologies, the media usually needs to be modified manually, which is not only time-consuming and labor-intensive, but also difficult for the modification effect to meet the needs of users. Therefore, a media processing method is desired at present.

### SUMMARY

Embodiments of the present disclosure describe a media processing method, an apparatus, a device, and a medium.

According to a first aspect, a method is provided, which includes: acquiring an original media to be modified and guidance information, where the guidance information includes text information for performing modification on the original media; determining a first area to be modified in the original media; acquiring a reference feature for modifying the original media based on the guidance information; and performing modification on the first area in the original media based on the reference feature to obtain a target media.

According to a second aspect, a media processing apparatus is provided, which includes: a first acquiring unit configured to acquire an original media to be modified and guidance information, where the guidance information includes text information for performing modification on the original media; a determining unit configured to determine a first area to be modified in the original media; a second acquiring unit configured to acquire a reference feature for modifying the original media based on the guidance information; and a modifying unit configured to perform modification on the first area in the original media based on the reference feature to obtain a target media.

According to a third aspect, a computer program product is provided, which includes a computer program for implementing any one of the above-mentioned first aspect when the computer program is executed by a processor.

According to a fourth aspect, a computer-readable storage medium is provided, where a computer program is stored on the computer-readable storage medium. The computer program causes a computer to execute the method according to any one of the above-mentioned first aspect when the computer program is executed in the computer.

According to a fifth aspect, an electronic device is provided, which includes a memory and a processor. Executable codes are stored in the memory. The executable codes implement the method according to any one of the above-mentioned first aspect when the executable codes are executed by the processor.

According to a media processing solution provided in embodiments of the present disclosure, an original media to be modified and guidance information are acquired, a first area to be modified in the original media is determined, a reference feature for modifying the original media is acquired based on the guidance information, and modification is performed on the first area in the original media based on the reference feature to obtain a target media.

### BRIEF DESCRIPTION OF THE DRAWINGS

FIG. 1 is a schematic diagram of a media processing scenario according to an exemplary embodiment;

FIG. 2 is a schematic diagram of an exemplary system architecture to which embodiments of the present disclosure are applied;

FIG. 3 is a flowchart of a media processing method according to an exemplary embodiment of the present disclosure;

FIG. 4 is a schematic diagram of a scenario of a media processing method according to an exemplary embodiment of the present disclosure;

FIG. 5 is a schematic diagram of a scenario of another media processing method according to an exemplary embodiment of the present disclosure;

FIG. 6 is a block diagram of a media processing apparatus according to an exemplary embodiment of the present disclosure; and

FIG. 7 is a schematic block diagram of an electronic device provided in some embodiments of the present disclosure.

### DETAILED DESCRIPTION OF EMBODIMENTS

It may be understood that before using the technical solutions disclosed in embodiments of the present disclosure, the user shall be informed of the type, the range of use, the use scenarios, etc., of personal information involved in the present disclosure in an appropriate manner and the authorization of the user shall be obtained in accordance with relevant laws and regulations.

For example, in response to receiving an active request from a user, prompt information is sent to the user to clearly inform the user that the requested operation will require access to and use of personal information of the user. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying the user and acquiring the authorization of the user is only illustrative and does not constitute a limitation on the implementations of the present disclosure. Other manners that satisfy the relevant laws and regulations may also be applied in the implementations of the present disclosure.

The technical solutions provided in the present disclosure are further described in detail below with reference to the drawings and embodiments. It may be understood that the specific embodiments described herein are only used to explain the related disclosure, rather than limiting the disclosure. In addition, it should be noted that, for the convenience of description, only the parts related to the disclosure are shown in the drawings. It should be noted that the embodiments of the present disclosure and the features in the embodiments may be combined with each other without conflict.

With the continuous development of artificial intelligence technology, artificial intelligence technology is increasingly applied to the field of media processing. At present, it has been possible to generate a media (such as an image, a video, or an animation, etc.) satisfying the wishes of a user by an artificial intelligence model. However, in some cases, the media needs to be modified. For example, errors exist in the generated media, or the user wants to adjust the content in some areas of the media. In particular, for some media including texts (such as advertisements, posters, and package designs, etc.), the texts included in the media usually need to be modified, such as adding texts, replacing texts, or deleting texts, etc. In related technologies, the media needs to be modified manually, which is not only time-consuming and labor-intensive, but also difficult for the modification effect to meet the needs of users, especially for some art text areas with a more natural combination effect with an image or a video background.

According to a media processing solution provided in the present disclosure, an original media to be modified and guidance information are acquired, a first area to be modified in the original media is determined, a reference feature for modifying the original media is acquired based on the guidance information, and modification is performed on the first area in the original media based on the reference feature to obtain a target media. In this way, the area to be modified in the original media can be modified according to the guidance information and the wishes of the user, thereby improving the modification effect of the media and enhancing the user experience.

FIG. 1 is a schematic diagram of a media processing scenario according to an exemplary embodiment.

As shown in FIG. 1, taking an image A including texts as an example, the image A includes texts “Happy Spring Festival”, and a user wants to change “Spring Festival” in the texts to “New Year's Day”. First, the user may import the image A into a media processing client and input a piece of guidance information B through a terminal device, where the guidance information B may include text information for describing the key semantics of the image A and the target text “New Year's Day” for modification. The key semantics may be preference semantics that the user pays more attention to and wants to highlight.

Next, the media processing client may display an operation interface for the image A to the user through the terminal device, and the user may select an area C1 of “Spring Festival” in the texts in the image A through the operation interface. For example, the user may smear the area of the text “Spring Festival”, or may select the area of the text “Spring Festival” with a box, etc. The media processing client may acquire the area C1 selected by the user as the area to be modified. The area C1 may also be occluded with a mask to obtain a masked image D, where the masked image D only displays an area C2 other than the area C1 in the image A.

Then, the media processing client may first use a pre-trained model M1 to perform feature extraction on the area C2 other than the area C1 in the image A to obtain a media style reference feature Z1 of the area C2. The media processing client may use a pre-trained model M2 to perform semantic feature extraction on the guidance information B to obtain a semantic reference feature Z2. The media processing client may further use a pre-trained model M3 to perform feature fusion on the media style reference feature Z1 and the semantic reference feature Z2 to obtain a reference feature Z. Optionally, the media processing client may also use a pre-trained text style extraction model M4 to extract a text style feature Z3 from the texts in the area C1. In addition, the media processing client may further acquire the target text “New Year's Day” to be generated from the guidance information B.

Finally, the target text “New Year's Day”, the reference feature Z, and the text style feature Z3 may be input into an image generation model M5, so that the image generation model M5 generates the text “New Year's Day” in the area C1 of the masked image D based on the text feature Z1, the reference feature Z, and the text style feature Z3 to replace the text “Spring Festival” in the image A, thereby obtaining a target image E. The target image E includes the text “Happy New Year's Day”, and the areas other than the modified target text “New Year's Day” in the target image E are the same as those in the image A, and the text style of the target text “New Year's Day” is the same as the text style of the text “Spring Festival” in the image A.

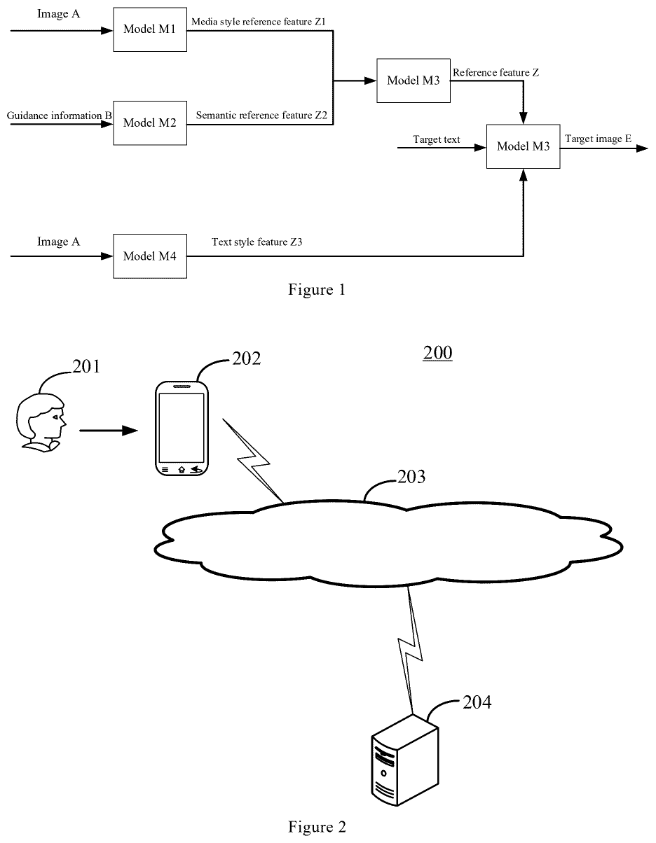

It should be noted that the embodiment of FIG. 1 is described by taking the media processing client directly processing the image A as an example. In other embodiments, the media processing client may also transmit information about the image A, the guidance information B, the masked image D, and the target text “New Year's Day” to a media processing server deployed on a service platform through a network, and the media processing server may modify the image A to obtain the target image E and transmit the target image E to the media processing client through the network, so as to provide the target image E to the user, as shown in FIG. 2.

FIG. 2 is a schematic diagram of an exemplary system architecture to which embodiments of the present disclosure are applied.

As shown in FIG. 2, the system architecture 200 may include a terminal device 202, a network 203, and a server 204. It should be understood that the number or type of the terminal device, the network, and the server in FIG. 2 is only illustrative. There may be any number or type of terminal device, network, and server according to implementation needs.

The network 203 is used as a medium for providing a communication link between the terminal device and the server. The network 203 may include various types of connections, such as a wired connection, a wireless communication link, or an optical fiber cable, etc.

A media processing client is installed in the terminal device 202, and the terminal device 202 may interact with the server through the network 203 to receive or transmit requests or information, etc. The terminal device 202 may be various electronic devices, including but not limited to a smart phone, a tablet computer, a laptop portable computer, a desktop computer, a smart wearable device, etc.

A media processing server is deployed in the server 204, and the server 204 may perform processing such as storing and analyzing on the received data, and may also send control commands or requests to the terminal device or other servers, etc. The server may provide media processing services in response to service requests from users. It may be understood that one server may provide one or more services, and the same service may also be provided by multiple servers.

Based on the system architecture shown in FIG. 2, in an embodiment of the present disclosure, a user 201 may input an original media to be processed and guidance information through the terminal device 202, and select a first area to be modified in the original media through the terminal device 202. Next, the terminal device 202 may transmit information about the original media, the guidance information, and the first area to the server 204 through the network 203. After receiving the information about the original media, the guidance information, and the first area, the server 204 may modify the first area in the original media based on the information about the original media, the guidance information, and the first area to obtain a target media. Finally, the server 204 may return the target media to the terminal device 202 through the network 203, so that the user 201 may view and save the target media through the terminal device 202.

The present disclosure will be described in detail below with reference to specific embodiments.

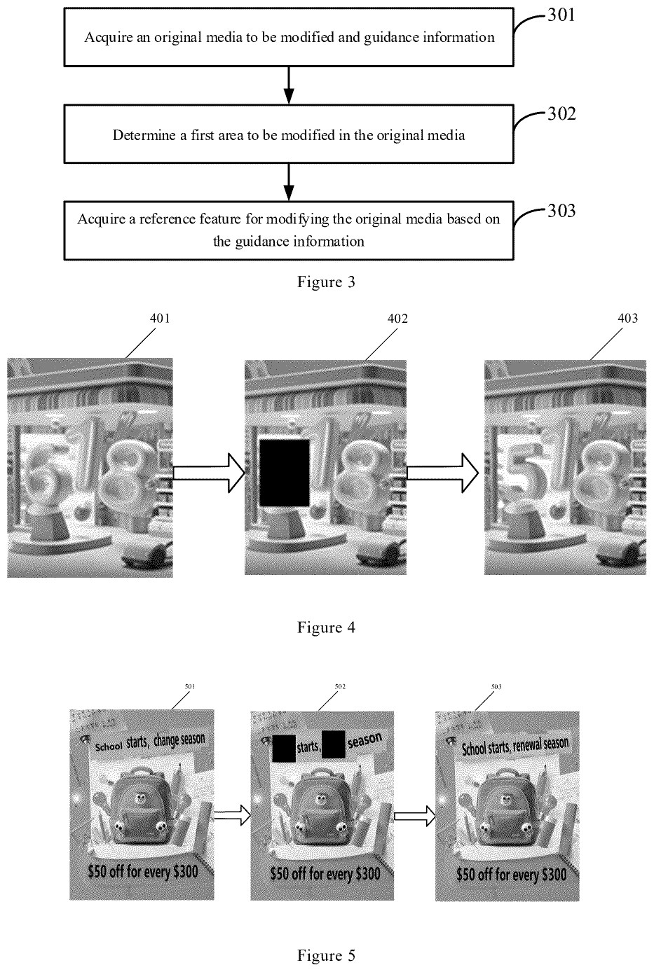

FIG. 3 is a flowchart of a media processing method according to an exemplary embodiment. The method may be applied to a media processing client or a media processing server. In this embodiment, the media processing client is installed in a terminal device, and the terminal device may include, but is not limited to, a mobile terminal device such as a smart phone, a smart wearable device, a tablet computer, a laptop computer, and a desktop computer, etc. The media processing server is deployed in a service platform, and the service platform may be implemented as any device, server or device cluster with computing and processing capabilities. The method may include the following steps.

As shown in FIG. 3, in step 301, an original media to be modified and guidance information are acquired.

In this embodiment, the involved media may include, but is not limited to, an image, a video, a dynamic image, an animation, etc., and the specific type of the media is not limited in this embodiment. The original media may be a media that needs to be modified locally, and the user needs to modify a specified area in the original media. For example, the original media may include an object, an animal, or a person, etc., and the user needs to modify a specified object area, a specified animal area, or a specified person area in the original media. For another example, the original media may include texts, and the user needs to modify a specified text area in the original media, such as adding texts, replacing texts, or deleting texts.

The guidance information may include text information for performing modification on the original media, and the original media may be modified according to the text information. For example, the text information may be target content for modifying the first area. The guidance information may further include text description information for describing the original media, and the text description information may be text information input by the user for describing the key semantics in the original media. The key semantics may be preference semantics that the user pays more attention to and wants to highlight. For example, the guidance information may further include the following information: “a poster with the number <5>18 as the central vision, a balloon-textured font, an e-commerce platform scene, candy colors, terracotta texture, a cartoon scene, and an exaggerated composition” (see the embodiment of FIG. 4). The content to be modified may be marked with < > symbols (here, the use of < > symbols for marking is only an example, and the specific manner for marking the content to be modified is not limited in this embodiment). It may be understood that the specific form and content of the guidance information are not limited in this embodiment.

In step 302, a first area to be modified in the original media is determined.

In this embodiment, the first area to be modified in the original media may be an area including an object to be modified. For example, if the object to be modified is a specified object, the first area may be an area including the specified object. For another example, if the object to be modified is a specified text, the first area may be an area including the specified text. In an implementation, the guidance information may further include a description of the object to be modified or the first area, and the original media may be parsed based on the description of the object to be modified or the first area in the guidance information to determine the first area.

In another implementation, the media processing client may further display an operation interface for the original media to a user through a terminal device, where the original media is displayed in the operation interface. The user may select an area that needs to be modified from the original media through the operation interface. For example, the user may select the area to be modified through a box selection operation, or may smear in the area to be modified, etc. It may be understood that the specific operation manner for the user to select the first area to be modified is not limited in this embodiment. Next, the media processing client may determine the first area selected in the original media according to the operation of the user on the operation interface.

In step 303, a reference feature for modifying the original media is acquired based on the guidance information.

In this embodiment, in some implementations, the guidance information may include text information for performing modification on the original media. In some other implementations, the guidance information may further include content describing the original media. Therefore, the reference feature for modifying the original media may be acquired according to the guidance information. The reference feature may include some semantic information that needs to be focused on in the original media, that is, information that the user expects to be retained after the original media is modified. In an implementation, a pre-trained first model may be used to perform semantic feature extraction on the guidance information to obtain a semantic reference feature, and the semantic reference feature may be directly used as the reference feature for modifying the original media. In another implementation, on the one hand, the pre-trained first model may be used to perform semantic feature extraction on the guidance information to obtain the semantic reference feature. On the other hand, a pre-trained second model may be used to perform media style feature extraction on a second area other than the first area in the original media to obtain a media style reference feature. Specifically, a mask may be first used to occlude the first area in the original media to obtain a masked media, and the unoccluded area in the masked media is the second area. The masked media may be input into the second model, so that the second model extracts a media style feature of the second area. Finally, feature fusion is performed on the semantic reference feature and the media style reference feature to obtain the reference feature. In this embodiment, not only the semantics described by the guidance information but also the media style feature of the area other than the area to be modified in the original media are considered, and the area to be modified is modified in combination with the context of the area to be modified in the original media, so that the modified area is better integrated with the surrounding area, and the effect of modifying the media is improved.

The first model for processing the guidance information may be a model that may process natural language and extract semantic features in the natural language. For example, the first model may be a large language model, etc., and the specific type of the first model is not limited in this embodiment. The second model for processing the second area in the original media may be a model that may extract media features. For example, the second model may be a variational autoencoder, etc., and the specific type of the second model is not limited in this embodiment. In addition, a neural network model capable of fusing features may be used to perform feature fusion on the semantic reference feature and the media style reference feature to obtain the reference feature.

In step 304, modification is performed on the first area in the original media based on the reference feature to obtain a target media.

In this embodiment, the first area in the original media may be modified based on the reference feature to obtain the target media. Specifically, in an implementation, the reference feature and the original media in which the first area is occluded may be directly input into a media generation model, so that the media generation model generates the target media for modifying the first area in the original media based on the reference feature.

In another implementation, the original media includes text content, such as texts, and the first area is in a text area corresponding to the text content. The guidance information further includes target text content for modifying the first area. The modification performed on the first area may be to change original text content in the first area to the target text content. First, text style information corresponding to the text content to be modified in the original media may be acquired. For example, a style extraction model may be used to process the texts in the first area to extract style information of the texts in the first area. The style information of the texts may include, for example, but is not limited to, the font of the texts, the color of the texts, the size of the texts, and the decoration around the texts, etc. It may be understood that the specific type of the style information of the texts is not limited in this embodiment. Then, the original text content in the first area is modified based on the reference feature according to the text style information. Specifically, the target text content for modifying the first area may be acquired first, and a media generation model may be used to replace the original text content in the first area with the target text content based on the target text content, the reference feature, and the text style information to obtain the target media. The media generation model may be an artificial intelligence model that may generate a media. For example, the media generation model may be a diffusion model, etc. It may be understood that the specific type of the media generation model is not limited in this embodiment.

According to a media processing method provided in the present disclosure, an original media to be modified and guidance information are acquired, a first area to be modified in the original media is determined, a reference feature for modifying the original media is acquired based on the guidance information, and modification is performed on the first area in the original media based on the reference feature to obtain a target media. In this way, the area to be modified in the original media may be modified according to the guidance information and the wishes of a user, thereby improving the modification effect of the media and enhancing the user experience.

It should be noted that although the operations of the method of the embodiments of the present disclosure are described in a particular order in the above embodiments, this is not required or implied that the operations must be performed in this particular order, or all of the illustrated operations must be performed to achieve the desired results. Instead, the order of execution of the steps depicted in the flowcharts may be changed. Additionally or alternatively, some steps may be omitted, multiple steps may be combined into one step for execution, and/or one step may be decomposed into multiple steps for execution.

The solution and effect of the present disclosure are schematically described below with reference to a complete and specific application example.

Referring to FIG. 4, taking an image as an example, an image 401 is an original media, and the image 401 includes the text “618”, and a user expects to change “618” to “518”. Therefore, first, the user may input the image 401 into a media processing client and input the following guidance information: “a poster with the number <5>18 as the central vision, a balloon-textured font, an e-commerce platform scene, candy colors, terracotta texture, a cartoon scene, and an exaggerated composition”. The guidance information includes the target text <5> to be modified and text description information about some semantic features of the image 401 from the user.

Next, the user may select the text “6” to be modified in the image 401 through an operation interface provided by the media processing client. The media processing client may occlude an area corresponding to the text “6” in the image 401 to obtain an image 402. An image 403 may be generated according to the image 402 and the above guidance information, in which the text “5” replaces the text “6” in the image 401.

Referring to FIG. 5, still taking an image as an example, an image 501 is an original media, and the image 501 includes the text “School starts, change season”, and a user expects to change “change” to “renewal” and enlarge “school”. Therefore, first, the user may input the image 501 into a media processing client and input guidance information that may instruct to enlarge the word “school” and change “change” to “renewal”.

Next, the user may select the texts “school” and “change” to be modified in the image 501 through an operation interface provided by the media processing client. The media processing client may occlude areas corresponding to the texts “school” and “change” in the image 501 to obtain an image 502. An image 503 may be generated according to the image 502 and the above guidance information, in which the text “renewal” replaces the text “change” in the image 501, and the text “school” is enlarged.

Corresponding to the foregoing media processing method embodiments, the present disclosure further provides embodiments of a media processing apparatus.

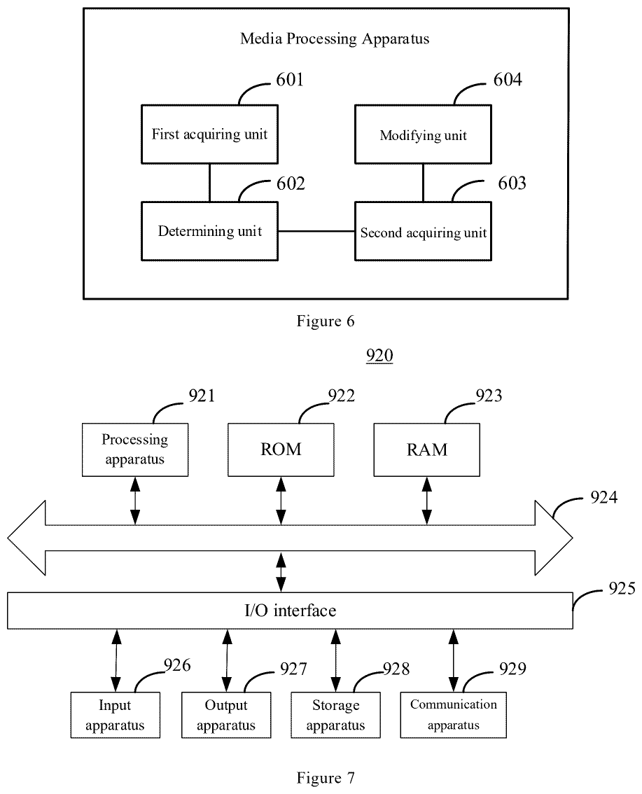

As shown in FIG. 6, which is a block diagram of a media processing apparatus according to an exemplary embodiment of the present disclosure, the apparatus includes: a first acquiring unit 601, a determining unit 602, a second acquiring unit 603, and a modifying unit 604.

The first acquiring unit 601 is configured to acquire an original media to be modified and guidance information, where the guidance information includes text description information for performing modification on the original media.

The determining unit 602 is configured to determine a first area to be modified in the original media.

The second acquiring unit 603 is configured to acquire a reference feature for modifying the original media based on the guidance information.

The modifying unit 604 is configured to perform modification on the first area in the original media based on the reference feature to obtain a target media.

In some implementations, the determining unit 602 is configured to display an operation interface for the original media and determine an area selected from the original media through the operation interface as the first area.

In some other implementations, the second acquiring unit 603 is configured to use a pre-trained first model to perform semantic feature extraction on the guidance information to obtain a semantic reference feature and determine the reference feature based on the semantic reference feature.

In some other implementations, the second acquiring unit 603 determines the reference feature based on the semantic reference feature in the following manners: a pre-trained second model is used to perform media style feature extraction on a second area other than the first area in the original media to obtain a media style reference feature, and feature fusion is performed on the semantic reference feature and the media style reference feature to obtain the reference feature.

In some other implementations, the original media includes text content, the first area is in a text area corresponding to the text content, and the text information for performing modification on the original media further includes target text content for modifying the first area, wherein the modification performed on the first area includes changing original text content in the first area to the target text content.

In some other implementations, the modifying unit 604 is configured to acquire text style information corresponding to the original text content to be modified in the first area and modify the original text content in the first area to the target text content according to the text style information based on the reference feature.

In some other implementations, the modifying unit 604 modifies the original text content in the first area to the target text content according to the text style information based on the reference feature in the following manner: a media generation model is used to replace the original text content in the first area with the target text content based on the target text content, the reference feature, and the text style information to obtain the target media.

In some other implementations, the guidance information may further include text description information for describing at least part of the semantics in the original media.

For the apparatus embodiment, since it basically corresponds to the method embodiment, reference may be made to the part of the description of the method embodiment for relevant parts. The apparatus embodiment described above is only schematic, and the units described as separate parts may be physically separated or not, and the parts displayed as units may be physical units or not, that is, they may be located in one place or distributed to multiple network units. Some or all of the modules may be selected according to actual needs to achieve the objectives of the solutions of the embodiments of the present disclosure. Those of ordinary skill in the art may understand and implement without paying any creative effort.

Reference is made to FIG. 7 below, which is a schematic block diagram of an electronic device provided in some embodiments of the present disclosure. The electronic device 920 is, for example, suitable for implementing the media processing method provided in the embodiments of the present disclosure. The electronic device 920 may be a terminal device, etc., and may be used to implement a client or a server. The electronic device 920 may include, but is not limited to, mobile terminals such as a mobile phone, a laptop computer, a digital broadcast receiver, a personal digital assistant (PDA), a tablet computer (PAD), a portable media player (PMP), a vehicle-mounted terminal (e.g., a vehicle navigation terminal), and a wearable electronic device, etc., and stationary terminals such as a digital TV, a desktop computer, and a smart home device, etc. It should be noted that the electronic device 920 shown in FIG. 7 is only an example, which will not impose any limitation on the functions and the range of use of the embodiments of the present disclosure.

As shown in FIG. 7, the electronic device 920 may include a processing apparatus (such as a central processing unit, a graphics processing unit, etc.) 921, which may perform various appropriate actions and processing according to a program stored in a read-only memory (ROM) 922 or a program loaded from a storage apparatus 928 into a random access memory (RAM) 923. The RAM 923 further stores various programs and data required for the operation of the electronic device 920. The processing apparatus 921, the ROM 922, and the RAM 923 are connected to each other through a bus 924. An input/output (I/O) interface 925 is also connected to the bus 924.

Usually, the following apparatuses may be connected to the I/O interface 925: an input apparatus 926 including, for example, a touch screen, a touchpad, a keyboard, a mouse, a camera, a microphone, an accelerometer, and a gyroscope, etc.; an output apparatus 927 including, for example, a liquid crystal display (LCD), a speaker, and a vibrator, etc.; a storage apparatus 928 including, for example, a magnetic tape and a hard disk, etc.; and a communication apparatus 929. The communication apparatus 929 may allow the electronic device 920 to perform wireless or wired communication with other electronic devices to exchange data. Although FIG. 7 shows the electronic device 920 with various apparatuses, it should be understood that it is not required to implement or have all of the illustrated apparatuses, and the electronic device 920 may alternatively implement or have more or fewer apparatuses. Each block shown in FIG. 7 may represent one apparatus or multiple apparatuses as needed.

According to an embodiment of the present disclosure, the above media processing method may be implemented as a computer software program. For example, an embodiment of the present disclosure includes a computer program product, which includes a computer program carried on a non-transitory computer-readable medium, where the computer program includes program codes for performing the above media processing method. In such an embodiment, the computer program may be downloaded and installed from a network through the communication apparatus 929, or installed from the storage apparatus 928, or installed from the ROM 922. When the computer program is executed by the processing apparatus 921, the functions defined in the media processing method provided by the embodiments of the present disclosure may be implemented.

An embodiment of the present disclosure further provides a computer-readable storage medium, on which a computer program is stored. When the computer program is executed in a computer, the computer program causes the computer to execute the method provided in the present disclosure.

It should be noted that the computer-readable medium described in the embodiments of the present disclosure may be a computer-readable signal medium, a computer-readable storage medium, or any combination of the above. The computer-readable storage medium may be, for example, but is not limited to, an electrical, magnetic, optical, electromagnetic, infrared, or semi-conductive system, apparatus, device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In an embodiment of the present disclosure, the computer-readable storage medium may be any tangible medium that contains or stores a program, which may be used by or in combination with an instruction execution system, apparatus, or device. In an embodiment of the present disclosure, the computer-readable signal medium may include a data signal propagated on a baseband or as a part of a carrier wave, and computer-readable program codes are carried in the data signal. The data signal propagated in this manner may be in multiple forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program codes contained on the computer-readable medium may be transmitted by any suitable medium, including but not limited to: a wire, an optical cable, a radio frequency (RF), etc., or any suitable combination of the above.

The computer program codes for performing the operations in the embodiments of the present disclosure may be written in one or more programming languages or a combination thereof, where the programming languages include object-oriented programming languages such as Java, Smalltalk, and C++, and may also include conventional procedural programming languages such as “C” language or similar programming languages. The program codes may be executed entirely on a computer of a user, partly on the computer of the user, as a stand-alone software package, partly on the computer of the user and partly on a remote computer, or entirely on the remote computer or server. In the case of involving the remote computer, the remote computer may be connected to the computer of the user through any kind of network, including a local area network (LAN) or a wide area network (WAN), or it may be connected to an external computer (for example, connected by using Internet provided by an Internet service provider).

The embodiments in the present disclosure are described in a progressive manner, and the same or similar parts between the embodiments may be referred to each other, and each embodiment focuses on the differences from other embodiments. In particular, the embodiments of the storage medium and the computing device are described relatively briefly since they are basically similar to the method embodiment, and the relevant parts may be referred to the description of the method embodiment.

Those skilled in the art should be aware that, in one or more of the above examples, the functions described in the embodiments of the present disclosure may be implemented by hardware, software, firmware, or any combination thereof. When software is used to implement these functions, these functions may be stored in a computer-readable medium or transmitted as one or more instructions or codes on the computer-readable medium.

The above specific embodiments further explain the objectives, technical solutions and beneficial effects of the embodiments of the present disclosure in detail. It should be understood that the above are only specific implementing modes of the embodiments of the present disclosure, and are not intended to limit the scope of protection of the present disclosure. Any modifications, equivalent substitutions, improvements, etc. made on the basis of the technical solutions of the present disclosure shall be included in the scope of protection of the present disclosure.

1. A media processing method, comprising:
acquiring an original media to be modified and guidance information, wherein the guidance information comprises text information for performing modification on the original media;
determining a first area to be modified in the original media;
acquiring a reference feature for modifying the original media based on the guidance information; and
performing modification on the first area in the original media based on the reference feature to obtain a target media.

2. The method of claim 1, wherein the determining the first area to be modified in the original media comprises:
displaying an operation interface for the original media; and
determining an area selected from the original media through the operation interface as the first area.

3. The method of claim 1, wherein the acquiring the reference feature for modifying the original media based on the guidance information comprises:
performing semantic feature extraction on the guidance information using a pre-trained first model to obtain a semantic reference feature; and
determining the reference feature based on the semantic reference feature.

4. The method of claim 3, wherein the determining the reference feature based on the semantic reference feature comprises:
performing media style feature extraction on a second area other than the first area in the original media using a pre-trained second model to obtain a media style reference feature; and
performing feature fusion on the semantic reference feature and the media style reference feature to obtain the reference feature.

5. The method of claim 1, wherein the original media comprises text content, the first area is in a text area corresponding to the text content, and the text information for performing modification on the original media comprises target text content for modifying the first area, wherein the modification performed on the first area comprises modifying original text content in the first area to the target text content.

6. The method of claim 5, wherein the performing modification on the first area in the original media based on the reference feature comprises:
acquiring text style information corresponding to the original text content to be modified in the first area; and
modifying the original text content in the first area to the target text content according to the text style information based on the reference feature.

7. The method of claim 6, wherein the modifying the original text content in the first area to the target text content according to the text style information based on the reference feature comprises:
using a media generation model to replace the original text content in the first area with the target text content based on the target text content, the reference feature, and the text style information to obtain the target media.

8. The method of claim 1, wherein the guidance information further comprises text description information for describing at least part of semantics in the original media.

9. A non-transitory computer-readable storage medium, wherein a computer program is stored on the computer-readable storage medium, and the computer program, when executed in a computer, causes the computer to execute a media processing method, the media processing method comprising:
acquiring an original media to be modified and guidance information, wherein the guidance information comprises text information for performing modification on the original media;
determining a first area to be modified in the original media;
acquiring a reference feature for modifying the original media based on the guidance information; and
performing modification on the first area in the original media based on the reference feature to obtain a target media.

10. The non-transitory computer-readable storage medium of claim 9, wherein the determining the first area to be modified in the original media comprises:
displaying an operation interface for the original media; and
determining an area selected from the original media through the operation interface as the first area.

11. The non-transitory computer-readable storage medium of claim 9, wherein the acquiring the reference feature for modifying the original media based on the guidance information comprises:
performing semantic feature extraction on the guidance information using a pre-trained first model to obtain a semantic reference feature; and
determining the reference feature based on the semantic reference feature.

12. The non-transitory computer-readable storage medium of claim 11, wherein the determining the reference feature based on the semantic reference feature comprises:
performing media style feature extraction on a second area other than the first area in the original media using a pre-trained second model to obtain a media style reference feature; and
performing feature fusion on the semantic reference feature and the media style reference feature to obtain the reference feature.

13. The non-transitory computer-readable storage medium of claim 9, wherein the original media comprises text content, the first area is in a text area corresponding to the text content, and the text information for performing modification on the original media comprises target text content for modifying the first area, wherein the modification performed on the first area comprises changing original text content in the first area to the target text content.

14. The non-transitory computer-readable storage medium of claim 13, wherein the performing modification on the first area in the original media based on the reference feature comprises:
acquiring text style information corresponding to the original text content to be modified in the first area; and
modifying the original text content in the first area to the target text content according to the text style information based on the reference feature.

15. An electronic device, comprising a memory and a processor, wherein executable codes are stored in the memory, and a media processing method is implemented when the executable codes are executed by the processor, the media processing method comprising:
acquiring an original media to be modified and guidance information, wherein the guidance information comprises text information for performing modification on the original media;
determining a first area to be modified in the original media;
acquiring a reference feature for modifying the original media based on the guidance information; and
performing modification on the first area in the original media based on the reference feature to obtain a target media.

16. The electronic device of claim 15, wherein the determining the first area to be modified in the original media comprises:
displaying an operation interface for the original media; and
determining an area selected from the original media through the operation interface as the first area.

17. The electronic device of claim 15, wherein the acquiring the reference feature for modifying the original media based on the guidance information comprises:
performing semantic feature extraction on the guidance information using a pre-trained first model to obtain a semantic reference feature; and
determining the reference feature based on the semantic reference feature.

18. The electronic device of claim 17, wherein the determining the reference feature based on the semantic reference feature comprises:
performing media style feature extraction on a second area other than the first area in the original media using a pre-trained second model to obtain a media style reference feature; and
performing feature fusion on the semantic reference feature and the media style reference feature to obtain the reference feature.

19. The electronic device of claim 15, wherein the original media comprises text content, the first area is in a text area corresponding to the text content, and the text information for performing modification on the original media comprises target text content for modifying the first area, wherein the modification performed on the first area comprises changing original text content in the first area to the target text content.

20. The electronic device of claim 19, wherein the performing modification on the first area in the original media based on the reference feature comprises:
acquiring text style information corresponding to the original text content to be modified in the first area; and
modifying the original text content in the first area to the target text content according to the text style information based on the reference feature.
